(19) United States
(12) Patent Application Publication
(10) Pub. No.: US 2006/0126149 A1
(43) Pub. Date: Jun. 15, 2006

(54) Technique for inducing frequency selective changes in a photosensitive material

(75) Inventors: Matthew Sellars, O'Connor ACT (AU); Neil B. Manson, Melba ACT (AU)

Correspondence Address: LADAS & PARRY LLP, 224 SOUTH MICHIGAN AVENUE, SUITE 1600, CHICAGO, IL, 60604, US

(73) Assignee: The Australian National University, Acton (AU)

(21) Appl. No.: 10/332,194

(22) PCT Filed: Jul. 9, 2001
(86) PCT No.: PCT/AU01/00824

§ 371 Date: May 29, 2003

(51) Int. Cl. G02B 26/00

(52) U.S. Cl. 359/237

(57) ABSTRACT

This invention relates to a technique for inducing frequency selective changes in photo-sensitive materials. It is known to store data in photo-sensitive materials using frequency selective optical data storage (FSDS). In order to improve the storage density, the present invention proposes storing data in the photo-sensitive material using a single side band technique. In one embodiment, a reference pulse is utilised having a frequeny band which encompasses only a single side band of the encoded signal. In another embodiment, a filter is utilised to filter out all frequencies apart from the single side band to be written into the material. As well as being useful for storing data in the photo-sensitive material, the single side band technique can also be used to store filter characteristics.

### FIELD OF THE INVENTION

This invention relates broadly to a technique for inducing frequency selective changes in a photosensitive material.

### BACKGROUND OF THE INVENTION

Data can be stored in an optical material, usually in the form of a crystal, by directing a beam of light, which encompasses the optical data, at the storage material. Exposing the optical material in this way results in the beam of light interacting with the atoms and molecules in the optical material and leading to changes in the material which are associated with data being planted in the optical material. At any later point, after the data has been stored in the material, the data can be read and retrieved from the material by a second exposure of the material with the appropriate light beam. In general, the internal spatial dimensions of individual storage cells in optical media can never be less than the wavelength of light used to register the data into the optical storage material and read the data from the material. Consequently, the storage density is determined by the wavelength of the light used. Since the wavelength of lasers is of the order of 10⁻³ mm, the maximum number of spatial storage cells is 10⁹ per mm³. This storage capacity of the material is well below that of an ideal optical storage device which can permit a bit of data to be stored in almost every atom or molecule of the storage material.

Frequency selective optical data storage (FSDS) is a technique that has a high storage density. This technique utilises a data storage material in which the storage cells exhibit an inhomogeneously broadened absorption profile. The entire cell does not undergo a photo-induced change in optical properties. Rather, only those atoms or molecules in the cell having a value at a resonant frequency corresponding to the particular incident frequency undergo such a photo-induced change. This results in formation of a “notch” or a “hole” in the inhomogeneously broadened spectrum at the particular resonant frequency.

Frequency domain optical memory (FDOM) and time domain optical memory (TDOM) are two general types of FSDS optical memories that can give rise to the same data storage density. Briefly, FDOM techniques sequentially address the different frequency channels. Usually, a monochromatic laser source is used to access a single frequency channel at an instant in time. To write data into the storage material, the laser is tuned to the frequency of the channel to be accessed. A controllable shutter is then opened so that the storage material is then exposed to the laser beam. The length of time the shutter must be open must be calculated appropriately so that only the desired frequency channel is accessed during the exposure of the material. In general the narrower the spectral channel the longer the access time required to write the data into the optical material.

The problem of long access time for a single channel can be overcome by addressing more than one frequency channel at a time. Writing to different frequency channels in parallel is the principle behind time domain optical memory (TDOM). By modulating a light pulse used to expose the storage material it is possible to introduce new frequencies of light, hence enabling the laser beam to access more than one frequency channel at a time. In this technique it is important to note that only the power spectrum of the pulse is recorded in the storage material. Consequently, the absolute phase relation between the different frequency components of the modulations is lost (although relative phase information is retained). However, a second pulse, known as a reference pulse, is employed to enable retention of sufficient information so that the time dependent modulations of the data pulse can be fully reconstructed. In this technique, therefore, two pulses are employed in writing the data. The “data pulse” which consists of the actual stream of data to be stored in the material and a “reference pulse” which aids in writing the data into the material, in a way such that it can be read and retrieved at a later point. Reading the data from the optical storage material involves using a “read pulse” which is typically identical to the “reference pulse.” As well as being used as a technique to store data into an optical material, TDOM has been shown to be an effective method for signal processing.

For signal processing where a wide dynamic range is required the saturation behaviour of TDOM can limit the maximum signal amplitude that can be processed. In TDOM techniques it is the maximum intensity signal at any given frequency that determines whether saturation will take place. Consequently, relatively weak monochromatic laser pules are capable of saturating the TDOM because most of the intensity is concentrated in only one frequency channel. This can be a problem for TDOM where the optical pulses are encoded using amplitude modulation (AM) or frequency modulation (FM) techniques. In both, AM and FM signals, when the modulation signal is small nearly all the light intensity is confined to the monochromatic carrier. To avoid the carrier saturating the storage material it is necessary to use low carrier intensities that can severely limit the dynamic range of the time dependent modulation signals encoded onto the carrier.

### SUMMARY OF THE INVENTION

In accordance with a first aspect, the present invention provides a method of inducing frequency selective changes in a photosensitive material, the method comprising the steps of modulating a carrier signal in a manner such that frequency side bands around the central carrier frequency of the carrier signal are produced; and exposing the photosensitive material to the modulated carrier signal and a reference signal in a manner such that only one of the side bands induces the frequency selective changes in the material.

It has been found by the applicant that it is not necessary to store the carrier signal in the photosensitive material. Rather, the carrier signal can be provided at a later stage for reading purposes. Accordingly, the saturation limit set by a high intensity of the carrier frequency can be avoided.

The step of exposing may comprise, in one embodiment, selecting the reference signal in a manner such that it overlaps in frequency only with the one side band so that only the one side band is effectively written into the material.

In another embodiment, the step of exposing may comprise filtering the modulated carrier signal in a manner such that the material is only exposed to the one side band and the reference signal. The filtering may be performed by way of a suitable filter characteristic imparted onto the material itself.

In an embodiment of the present invention the method is utilised for data storage, where the method comprises the steps of modulating the carrier signal to encode data therein and in a manner such that frequency side bands around the central carrier frequency of the carrier signal are produced; and exposing the optical storage material to the filtered modulated carrier signal and the reference signal in a manner such that only one of the side bands induces the frequency selective changes in the material, wherein the encoded data is stored in the material by way of the induced frequency selective changes.

In another embodiment of the present invention the method is utilised for fabricating a filter comprising the photosensitive material, where the method comprises the steps of modulating a carrier signal to encode a desired filter characteristic therein and in a manner such that frequency side bands around the central carrier frequency of the carrier signal are produced; and exposing a photosensitive material to the modulated carrier signal and the reference signal in a manner such that only one of the side bands induces the frequency selective changes in the material; whereby the filter characteristics are transferred into the material by way of the induced frequency selective changes.

In a preferred embodiment, where the method is utilised for data storage, the step of exposing the material may comprise utilising a filter constructed in accordance with an embodiment of the present invention for facilitating that only the one side band induces the frequency selected changes. Advantageously the filter is realised in the optical data storage material.

Further, in a preferred embodiment the step of modulating the carrier signal is performed in a manner such that the carrier frequency and the side bands are collinear.

Advantageously, the frequency selective changes induced in the material may comprise one or more of the following: modifying the absorption, modifying the emission, or modifying the reflection of a light beam interacting with the atoms or molecules of the photosensitive material.

Preferably the material used as a photosensitive material is Eu³+:Y₂SiO₅ with a dopant level of 0.1% and cooled to a temperature of 4 K.

In a second aspect, the present invention provides a method for reading data from a photosensitive material comprising the steps of exposing the material to a read signal, whereby the emission of an optical signal from the optical material is stimulated, and utilising the emitted optical signal and a carrier signal to retrieve the stored data; and wherein the emitted signal comprises only one frequency band corresponding to a side band of a modulated data carrier signal used in storing the data in the material.

Accordingly, data stored in accordance with the first aspect of the present invention can be read.

Preferably, the read signal is substantially identical to a reference signal used in storing the data in the material.

In accordance with a third aspect, the present invention provides an apparatus for inducing frequency selective changes in a photosensitive material, comprising a modulator for modulating a carrier signal in a manner such that frequency side bands around the central carrier frequency of the carrier signal are produced; and means for exposing the photosensitive material to the modulated carrier signal and a reference signal in a manner such that only one of the side bands induces the frequency selective changes in the material.

In a fourth aspect, the present invention provides an apparatus for reading data from a photosensitive material, comprising means for exposing the material to a read signal, whereby the emission of an optical signal from the optical material is stimulated, and means for detecting the emitted optical signal for retrieving the data from the optical signal, and wherein the emitted optical signal contains the stored data and comprises only one frequency band corresponding to a side band of a modulated data carrier signal used to store the data in the material. Accordingly, data stored in accordance with the first aspect of the present invention can be read.

### BRIEF DESCRIPTION OF THE DRAWINGS

FIG. 1 is a schematic diagram illustrating modulation of a data beam to produce a carrier signal with side bands;

FIG. 2 illustrates a signal comprising a carrier and side bands directed at a photo-sensitive storage medium together with a reference beam, in accordance with an embodiment of the present invention;

FIG. 3A is a spectral profile arranged to illustrate storage of a signal in a storage medium in accordance with an embodiment of the present invention;

FIG. 3B is a schematic diagram illustrating a modified absorption spectrum of the storage material after it has been written into in accordance with an embodiment of the present invention;

FIG. 4 is a schematic diagram illustrating steps in accordance with an embodiment of the present invention;

FIG. 5 is a schematic diagram illustrating reading of data from a storage medium in accordance with an embodiment of the present invention;

FIG. 6 is a diagram illustrating spectral profiles of various signals at different stages of a read process in accordance with an embodiment of the present invention;

FIG. 7 is schematic diagram arranged to illustrate the effect of a filter written into a photo-sensitive storage material, in accordance with an embodiment of the present invention;

FIG. 8 illustrates spectral profiles of signals at various stages in the filtering process illustrated in FIG. 7;

FIG. 9 is a schematic diagram of an apparatus used to demonstrate operation of an embodiment of the present invention;

FIG. 10 illustrates timing pulses utilised by the apparatus of FIG. 9, and

FIG. 11 shows an example of a signal recalled from a photo-sensitive material, the signal having been written and read in accordance with an embodiment of the present invention.

### DETAILED DESCRIPTION OF THE INVENTION

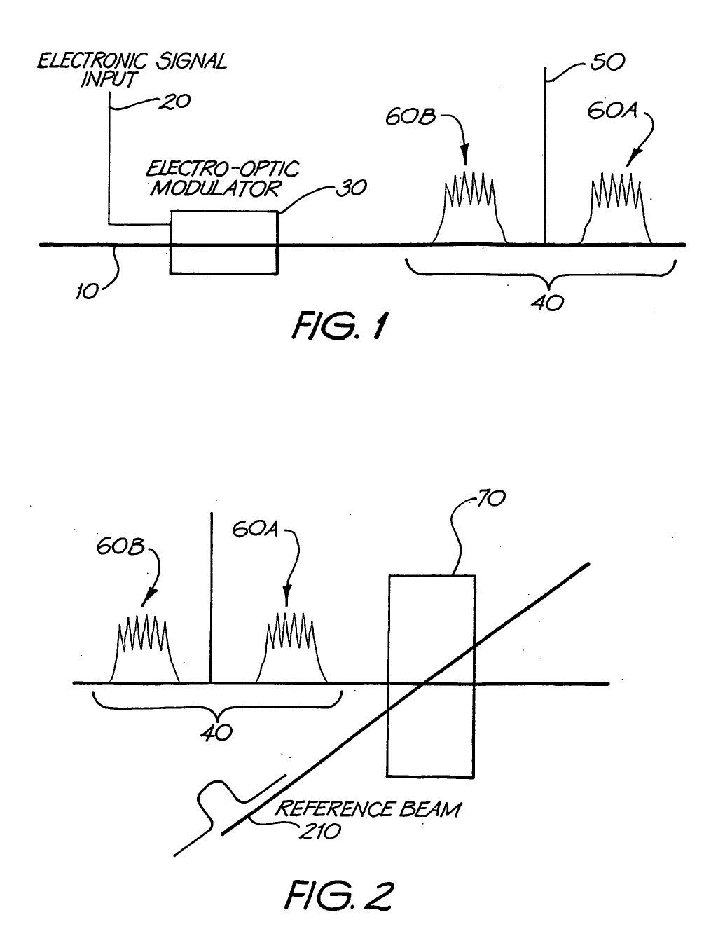

FIG. 1 shows an optical data beam 10 and an electronic signal input 20 being introduced into an electro-optic modulator 30. The resulting output spectrum 40 from the electro-optic modulator 30 is composed of a carrier frequency 50 and two modulated side bands 60A and 60B. FIG. 2 shows the spectrum 40 being then directed at a storage material 70 simultaneously with a reference beam 210, in accordance with an embodiment of the present invention.

The reference beam (or “write” beam) is in the form of a pulsed laser. The pulse 210 is arranged so that its Fourier width encompasses the frequency width of the upper side band 60A of the modulated carrier. The storage medium 70 is any suitable photo-sensitive storage medium able to display time division optical modulation (TDOM). The storage medium may be Eu³:Y₂SiO₅ with a dopant level in the order of 0.1%. Reference pulse 210 ensures that only the upper side band 60A is written into the TDOM medium 70. The frequency range of the modulated signal is sufficient to ensure that the required frequency selected changes are produced in the inhomogeneously broadened spectrum of the TDOM material 70.

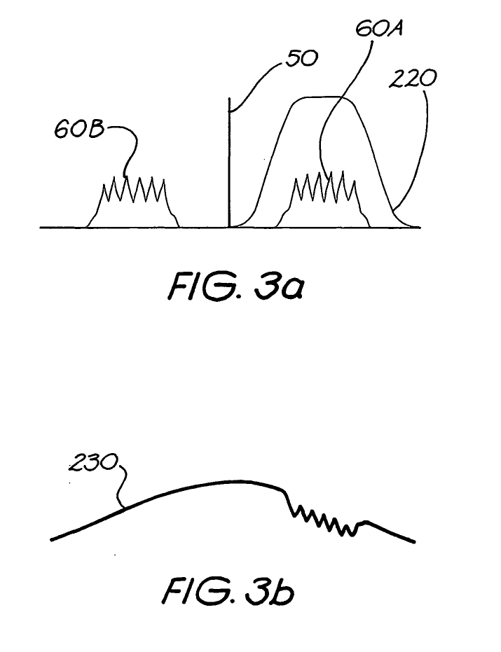

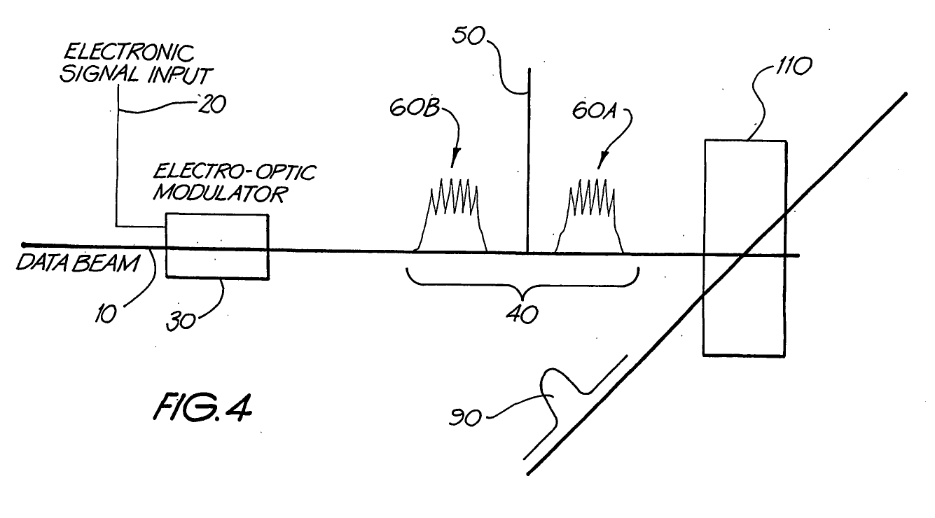

FIG. 3 a) shows the spectral overlap between the reference pulse 220 and the upper side bands 60A. FIG. 3 b) shows the spectrum 230 of the relevant modified absorption of the storage material 70. As is evident in FIG. 3 b), only the information contained in one of the sidebands 60 has been “stored”.

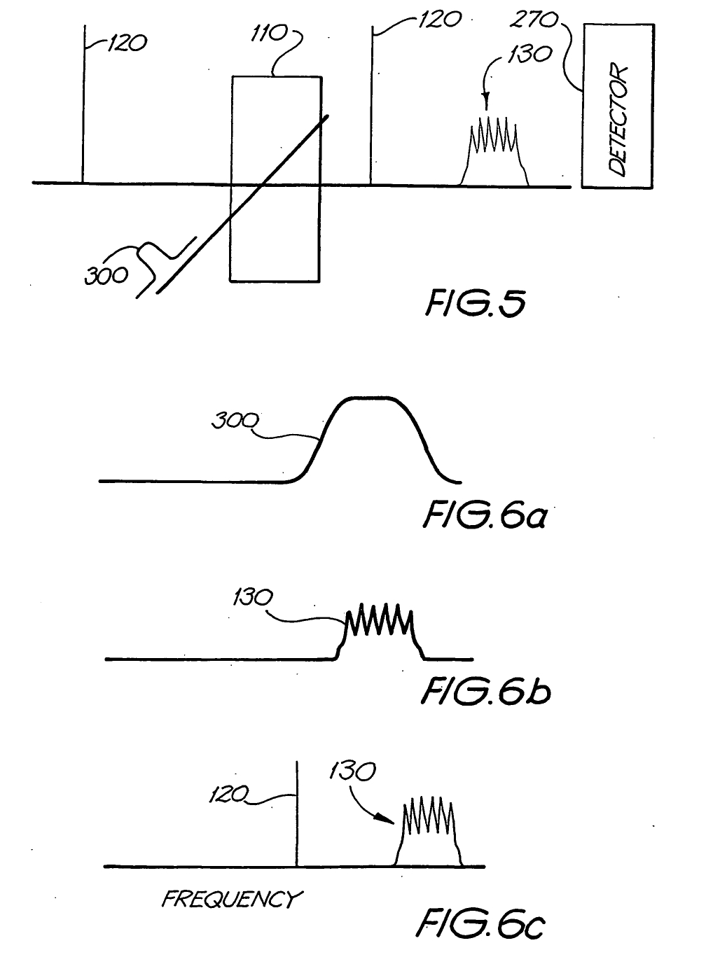

FIG. 4 illustrates an assembly of the stages illustrated in FIG. 1 and FIG. 2. An electronic input signal 20 modulates a data beam 10 to give the modulated carrier signal with the spectrum 40. Utilising a reference beam impulse 90 with a Fourier width encompassing the upper side band 60A of the modulated carrier signal, the upper side band 60A signal is “written in” to the photo-sensitive storage material 110, by way of the frequency selective changes induced in the storage material 110.

One of the main advantages to using the single side band technique for writing information into optical storage material is that the saturation point is not limited by the intensity of the carrier frequency 50, but rather by the most intense frequency component in the side band 60.

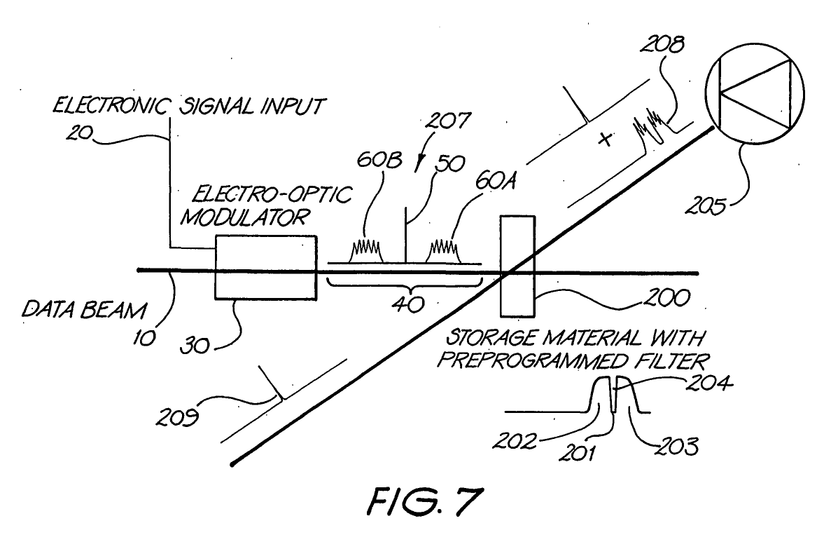

FIG. 5 illustrates a process for reading data from a storage material 110. Reading of the data requires exciting the storage medium 110 with a read pulse 300 which is the same in frequency width as the original write pulse (reference numeral 90 of FIG. 4). That is, the Fourier width of the read pulse 300 encompasses the frequency width of the upper side band signal 60A originally written into the storage medium 110. The read pulse 300 initiates the emission of an optical signal 130, which corresponds to the upper side band 60A of the modulated data carrier signal used to store the data in the material 110. The carrier frequency 120 is also transmitted in an unimpeded fashion, so that a signal comprising the carrier 120 and upper side band 130 can be detected by detector 270. This is the total signal that is required in order to be able to reproduce the data stored in the side band 130. The detector 270 reproduces all the relevant information by reconstruction from the beat between the carrier signal and the side band.

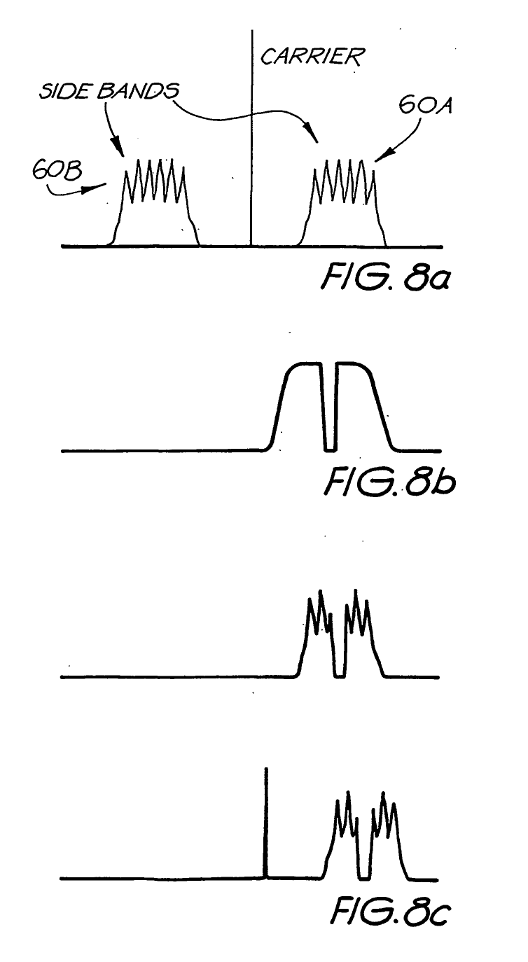

FIG. 6 shows the status of the pulses at different stages in the read process illustrated in FIG. 5. FIG. 6 a) shows the read pulse 300 which must be launched at the storage material. FIG. 6 b) shows the “side band” 130 that will be emitted as a result of the interaction between the read pulse 300 and the storage material 110 in which the data is encoded. FIG. 6 c) shows the signals that will reach the detector 270. All the information required to reconstruct the data is contained in the unimpeded carrier signal 120 and the single side band 130.

The above description in relation to FIGS. 1 to 6 illustrates how a signal can be written into and read from a photo-sensitive storage medium, in accordance with an embodiment of the present invention. In this embodiment the storage medium is used for data storage and subsequent reading. Writing of the single side band of information into the storage material is achieved by using a write pulse whose frequency range encompasses the single side band only. The other information is therefore not written into the storage material as the storage material is not stimulated by the carrier frequency and other side bands (which are not associated with any read pulses).

An alternative embodiment of the present invention can be used to pre-program a storage material with a particular filter i.e. so that the storage material acts as a filter. This is done by writing a particular frequency response into the storage material by using a writing pulse (no single pulse) with a particular desired frequency profile.

FIG. 7 illustrates an arrangement which includes a storage material 200 which has been pre-programmed with a particular filter response 201. The filter response 201 includes 2 band pass areas 202, 203 separated by a gap 204. This has been written into the storage material with appropriate write pulses.

FIG. 7 illustrates operation of the pre-programmed signal 201 on impinging signal beam 207. The signal beam 207 includes a carrier 50 and upper 60A and lower 60B side bands. The signal beam 207 is created from a data beam 10 modulating an electro-optic modulator 30 by an electronic input signal 20. The signal 207 is filtered by the filter 201 in the storage material 200 to produce an output signal 208 which comprises the upper side band 60A of the signal 207 filtered in accordance with the response of the pre-programmed filter 201. To then convert the signal 208 back down to radio frequency a further carrier signal 209 is introduced as a reference beam. The output is detected by a photo detector 205.

FIG. 8 summarises the relationship of the various signals shown in FIG. 7. FIG. 8 a) shows the modulated data signal 207 which is to be filtered. FIG. 8 b) shows the filter characteristics 201 that were initially imprinted into the material. FIG. 8 c) shows the optical output 208 from the filter/material and FIG. 8 d) shows the combined signals of the reference carrier signal 209 and the output from the filter/material detected for reconstruction of the information.

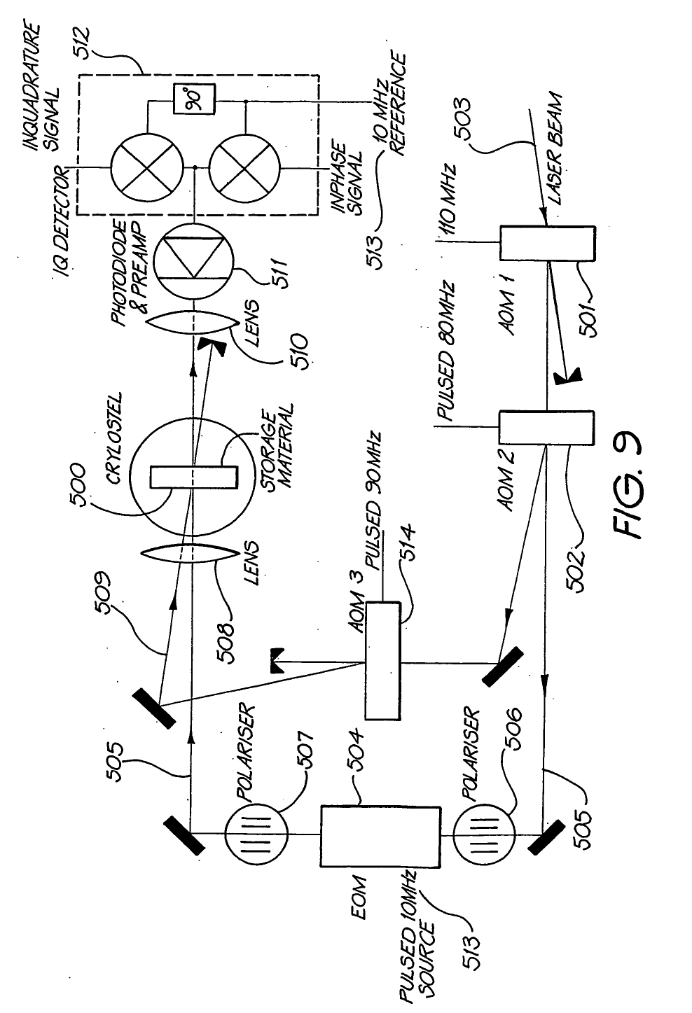

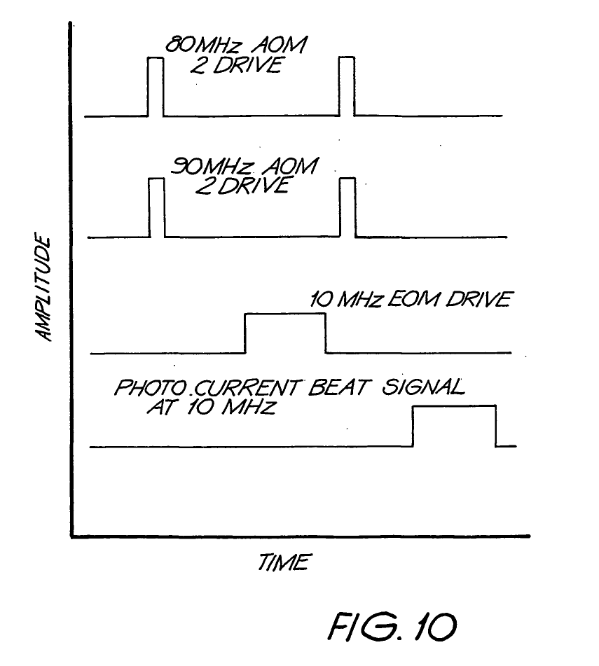

FIG. 9 illustrates an apparatus in accordance with an embodiment of the present invention which can be used to write data into an optical storage material 500 and also to read data from the optical storage material 500. The apparatus comprises a pair of acousto-optic modulators 501, 502 for modulating a source laser beam 503. The acousto-optic modulators 501, 502 are used to pulse the beam 503. The apparatus also includes a third acousto-optic modulator 514, an electro-optic modulator 504 for modulating a data beam 505 (from acousto-optic modulator 502) polarisers 506, 507, and lens 508 for focussing a modulated data beam 505 onto the storage material 500 together with a write/read beam 509 pulsed at 90 MHz by acousto-optic modulator 514. The arrangement also includes a lense 510 for focussing an output signal onto a photo diode detector 511. An inquadrature detector arrangement 512 detects the signal and extracts the data 513.

To demonstrate the effectiveness of this arrangement, the following experiment was carried out.

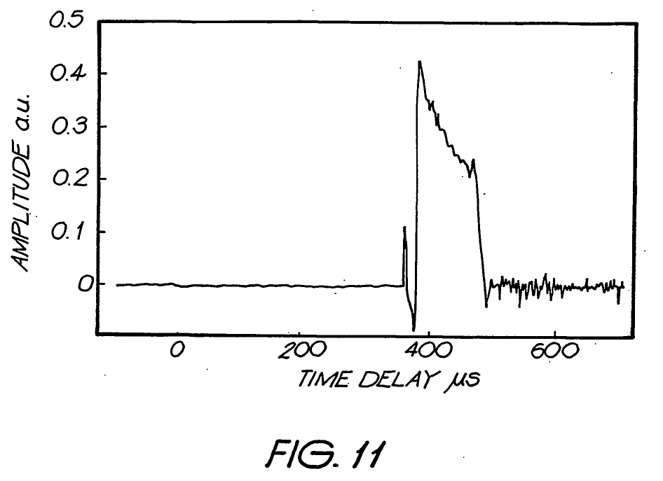

The storage material used was Eu³+:Y₂SiO₅ with a dopant level of 0.1% and was cooled to a temperature of 4 K. A frequency-stabilised laser 503 was tuned to an optical absorption at 579 nm. The data and reference beams 509 where overlapped in the sample with a 50 mrad angle between them. Both beams were focused to a spot size of 50 μm. The first AOM 501 was used to control the overall light intensity in the two beams. The other two AOMs 502, 514 were used to gate the reference pulse 509 and to shift the centre frequency of the reference pulse 10 MHz relative to the data beams'505 carrier frequency. This has the effect of moving the reference pulse to effectively encompass the upper side band of the modulated data beam 505. An AM signal was generated using an electro-optic modulator 504 positioned between two linear polariser 506, 507 driven by a 10 MHz rf pulse. The timing of all the pulses used are shown in FIG. 10. The resulting 10 MHz beat signal was detected with a silicon pin diode 511 and downconverted to a DC signal using an IQ detector 512 and a 10 MHz reference. An example of a recalled signal is shown in FIG. 11. The dynamic range of the signal was shown to be 40 dB. The limit for the maximum signal was set by the saturation of the store material by the 10 MHz side band. The detection limit was set by the noise on the photo-diode, which was shot noise limited.

This experiment therefore showed the effect of both writing and reading utilising the single side band technique in accordance with the present invention. It will be appreciated that if the write beam 509 is gated only once the data will remain in the storage material until illuminated again by the write beam 509 (this time operating as a read beam) . In the above experiment the storage material 500 is being written to and read from continuously.

The present invention can therefore be used to both write and read data into and from a photo-sensitive storage material, and also to write filters into a photo-sensitive storage material.

In the above described embodiment, the data is written into the photo-sensitive storage material by using a write pulse having a Fourier width which encompassing a single side band of the modulated carrier signal. Note that although this embodiment utilises the upper side band, the lower side band could be used in the alternative.

Further, rather than using a write beam which is a pulse encompassing the upper side band, the upper side band signal could be written into the storage material by utilising the storage material having a filter written into it which only allows the upper side band to be written into it. The write pulse then need only be set at the carrier frequency.

It will be appreciated that although only one example of a photo-sensitive storage material has been disclosed in the above description of the preferred embodiment, any suitable photo-sensitive material could be used with the present invention.

There are a range of photo-sensitive materials available, including the following: Eu3+:Y203, Er3+Y2SiO5, Eu3+:Y2SiO5, Pr3+Y2SiO5.

Some organic materials are also useful.

Although the present invention is particularly suitable for TDOM, it will be appreciated that it can be used with any FSDS memory. The present invention would also have application with FDOM.

It will be appreciated that the present invention can be used to record and read any data, either digital data or analog data.

Photo-sensitive storage media can be used as cache memories for storing data for short or long periods of time (depending upon the lifetime of the material). They are particularly useful for storing large amounts of data in a short period of time e.g. data beams from satellites.

When used as a filter, in accordance with the present invention, very sharp filters can be made in the storage material. Such a filter can be very useful in signal processing.

The present invention has a number of applications including e.g.,
the application of this technique to increase the dynamic range of signals stored in a time domain optical memory
the application of this technique to increase the dynamic range of signals that can be filtered using a time domain optical memory
the application of this technique for storing and or processing analog signals
the application of this technique to achieve shot noise limited detection in a time domain optical memory
the application of this technique to increase the maximum modulation bandwidth in a time domain optical memory
the application of this technique to convert double side band signals to single side band signals
the application of this technique to up and down converting signal frequencies
the application of this technique to processes involving chirped carriers to reduce the breakthrough of the optical carrier into other frequency channels.

In the claims that follow and in the summary of the invention, except where the context requires otherwise due to express language or necessary implication, the word “comprising” is used in the sense of “including”, i.e. the features specified may be associated with further features in various embodiments of the invention.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method of inducing frequency selective changes in a photosensitive material, the method comprising the steps of:
modulating a carrier signal in a manner such that frequency side bands around the central carrier frequency of the carrier signal are produced; and
exposing the photosensitive material to the modulated carrier signal and a reference signal in a manner such that only one of the side bands induces the frequency selective changes in the material.

2. A method as claimed in claim 1, wherein, where the method is utilised for storing data in the material, the method comprises the steps of:
modulating the carrier signal to encode data therein and in a manner such that frequency side bands around the central carrier frequency of the carrier signal are produced; and
exposing the optical storage material to the modulated carrier signal and the reference signal in a manner such that only one of the side bands induces the frequency selective changes in the material, wherein the encoded data is stored in the material by way of the induced frequency selective changes.

3. A method in accordance with claim 2, wherein the reference signal is arranged to encompass a single frequency side band only of the modulated carrier signal, whereby the single frequency side band only is written into the material.

4. A method in accordance with claim 2, wherein the photo-sensitive material incorporates a filter the band width of which encompasses only a single side band of the modulated carrier signal, whereby the single side band only of the modulated carrier signal is written into the material.

5. A method as claimed in claim 1, wherein the method is utilised for fabricating a filter comprising the photosensitive material, the method comprises the steps of:
modulating a carrier signal to encode a desired filter characteristic therein and in a manner such that the frequency side bands around the central carrier frequency of the carrier signal are produced; and
exposing the optical storage material to the modulated carrier signal and the reference signal in a manner such that only one of the side bands induces the frequency selective changes in the material, whereby the filter characteristics are transferred into the material by way of the induced frequency selective changes.

6. A method for reading data from a photosensitive material, the method comprising the steps of:
exposing the material to a read signal, whereby the emission of an optical signal from the optical material is stimulated, and utilising the emitted optical signal and a carrier signal to retrieve the stored data; and
wherein the emitted signal comprises only one frequency band corresponding to a side band of a modulated data carrier signal used to store the data in the material.

7. An apparatus for inducing frequency selective changes in a photosensitive material, the apparatus comprising:
means for modulating a carrier signal in a manner such that frequency side bands around the central carrier frequency of the carrier signal are being produced; and
means for exposing the photosensitive material to the modulated carrier signal and a reference signal in a manner such that only one of the side bands induces the frequency selective changes in the material.

8. An apparatus in accordance with claim 7, the apparatus being arranged to store data in the photo-sensitive material, and wherein the means for modulating a carrier signal includes a means for modulating the carrier signal to encode data therein and in a manner such that frequency side bands around the central carrier frequency of the carrier signal are produced, wherein the encoded data is stored in the material by way of the induced frequency selected changes.

9. An apparatus in accordance with claim 8, the means for exposing the photo-sensitive material to a reference signal being arranged such that the reference signal encompasses a single frequency side band only of the modulated carrier signal, whereby the single frequency side band only is written into the material.

10. An apparatus in accordance with claim 8, wherein the photo-sensitive material incorporates a filter the band width of which encompasses only a single side band of the modulated carrier signal, whereby the single side band only of the modulated carrier signal is written into the material.

11. An apparatus in accordance with claim 7, wherein the apparatus is arranged to fabricate a filter into the photo-sensitive material, and wherein the means for modulating the carrier signal includes a means for modulating the carrier signal to encode a desired filter characteristic therein, wherein the filter characteristics are transferred into the material by way of the induced frequency selective changes.

12. An apparatus for reading data from a photosensitive material, the apparatus comprises:
means for exposing the material to a carrier signal, whereby the emission of an optical signal from the optical material is stimulated, and means for detecting the emitted optical signal for retrieving the data from the optical signal, and wherein the emitted optical signal contains the stored data and comprises only one frequency band corresponding to a side band of a modulated data carrier signal used to store the data in the material.
